(19) United States
(12) Patent Application Publication
(10) Pub. No.: US 2012/0303304 A1
(43) Pub. Date: Nov. 29, 2012

(54) APPARATUS AND METHOD FOR DETECTING LOCATION OF UNDERGROUND FACILITY

(75) Inventors: Pyung KIM, Seongnam-si (KR); Yeol KIM, Yongin-si (KR)

(73) Assignee: EWOOTEC CO., LTD., Yongin-si (KR)

(21) Appl. No.: 13/474,092

(22) Filed: May 17, 2012

(30) Foreign Application Priority Data
May 25, 2011 (KR) 10-2011-0049584

(51) Int. Cl. G06F 19/00

(52) U.S. Cl. 702/65

(57) ABSTRACT

The present invention provides an apparatus and method for detecting a location of an underground facility, which calculates a gauss value at each depth of a magnetic marker, measures a magnetic field at each depth through each sensor based on the calculated gauss values, extracts factors by performing a factor analysis on the measured magnetic fields, obtains extracted variable values by performing a regression analysis on the extracted factors, stores the extracted variable values in a database, and determines a location of the magnetic marker based on the stored extracted variable values and the values measured by the sensors in real time.

### CROSS-REFERENCE TO RELATED APPLICATION

This application claims priority to and the benefit of Korean Patent Application No. 10-2011-0049584, filed on May 25, 2011, the disclosure of which is incorporated herein by reference in its entirety.

### BACKGROUND

1. Field of the Invention

The present invention relates to an apparatus and method for detecting a location of an underground facility, which can accurately detect a location of a magnetic marker by quantifying a gauss value of each sensor as a variable through a factor analysis and a regression analysis and using the quantified data.

2. Discussion of Related Art

With the rapid urbanization and industrialization, the construction of infrastructures such as water and sewage pipes, gas pipes, communication lines, etc. increases sharply. Most of these facilities are buried underground for reasons of aesthetics, protection of the facilities, etc. However, detailed information on the locations and depths of these underground facilities is not disclosed, and thus it is difficult to determine their location or state, thereby making it difficult to maintain and administer such facilities. Moreover, when a new underground facility is installed or a building is constructed, the time and cost required for accurately determining the locations of existing underground facilities are increased and, when their location is not accurately determined, the underground facilities may be damaged, thus threatening the security of workers. To prevent these accidents, a variety of detection techniques for accurately detecting the locations of underground facilities are used. However, the conventional apparatus for detecting a location of an underground facility can detect a ferromagnetic marker, which is distinguished from soft ferrite, but cannot detect the depth of the underground facility.

The applicant of the present invention has discloses an “Apparatus for detecting underground facility and method for detecting underground facility using the same” issued on Mar. 8, 2010 in Korean Patent No. 10-0947659. The above patent provides an apparatus for detecting an underground facility, which can accurately calculate the depth of a magnetic marker by comparing a measurement value of magnetic flux density generated from the magnetic marker attached to the underground facility with a reference value pre stored in the apparatus.

However, according to the conventional apparatus, the value read from each sensor should be compared one by one by continuous testing to detect the presence of a magnetic marker, thereby causing inconvenience to a user.

### SUMMARY OF THE INVENTION

The prevent invention has been made in an effort to solve the above-described problems associated with the prior art, and an object of the present invention is to provide an apparatus and method for detecting a location of an underground facility, in which a gauss value of each sensor is quantified as a variable and stored through a factor analysis and a regression analysis to accurately detect the presence and depth of a magnetic marker based on the quantified data.

According to an aspect of the present invention for achieving the above objects, there is provided a method for detecting a location of an underground facility, the method comprising the steps of: calculating a gauss value at each depth of a magnetic marker; measuring a magnetic field using each sensor at each depth based on the calculated gauss value; extracting factors by performing a factor analysis on the measured magnetic fields; obtaining and obtaining and storing extracted variable values by performing a regression analysis on the extracted factors; and determining a location of the magnetic marker based on the stored extracted variable values and the values measured by the sensors in real time.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram showing a method for detecting an underground facility in accordance with a preferred embodiment of the present invention;

FIG. 2 is a block diagram showing an apparatus for detecting an underground facility in accordance with a preferred embodiment of the present invention;

FIG. 3 is a circuit diagram showing the configuration of a detector in FIG. 2;

FIG. 4 is a flowchart showing a method for detecting a location of an underground facility in accordance with a preferred embodiment of the present invention; and

FIG. 5 is a graph showing a regression formula in accordance with a preferred embodiment of the present invention.

Description of reference numerals

| | |
|---|---|
| 1: magnetic marker | 10: detector |
| 11: support rod | 12a, 12b & 12c: detection sensor |
| 13: microprocessor | 20: DGPS receiver |
| 30: horizontal sensor | 40: external connection device |
| 50: display device | 60: audio output device |
| 70: master processor | 100: detection apparatus |

### DETAILED DESCRIPTION OF EXEMPLARY EMBODIMENTS

Hereinafter, exemplary embodiments of the present invention will be described in detail below with reference to the accompanying drawings such that those skilled in the art to which the present invention pertains can easily practice the present invention.

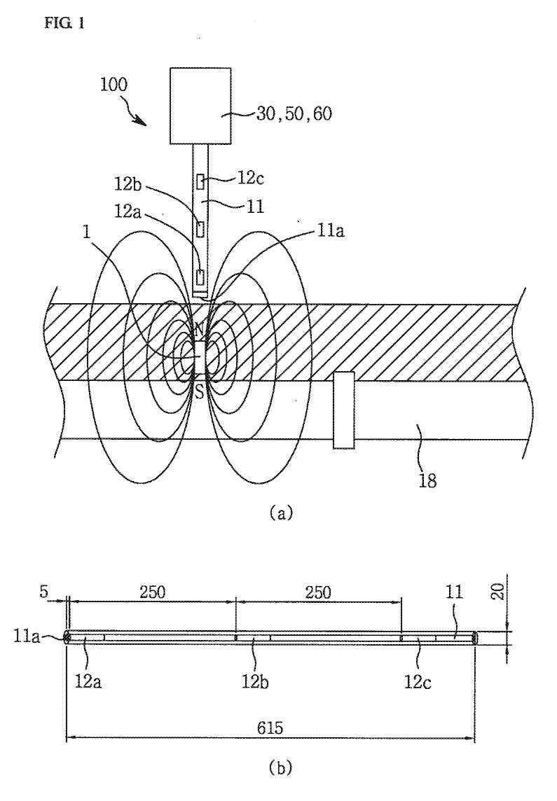

FIG. 1 is a diagram showing a method for detecting an underground facility in accordance with a preferred embodiment of the present invention.

As shown in (a) of FIG. 1, a magnetic marker 1 is attached to an underground facility 18 such as water and sewage pipe, gas pipes, communication lines, etc. The magnetic marker 1 is prepared by waterproof coating, moistureproof coating, nickel plating, or urethane film coating on a permanent magnet having a predetermined magnetic force such as ferrite. The magnetic marker 1 is installed in such a manner that the N pole is located at the top, and according to circumstances, the S pole may be located at the top.

When the magnetic markers 1 are installed, it is necessary to select the type of magnetic marker 1 according to installation standards. The installation standards of the magnetic markers 1 are as shown in the following Table 1.

TABLE 1

| | | Suggested | |
|---|---|---|---|
| Classification | Dimensions (mm) | depths (m) | Number of use |
| General type | 50 × 20T | 0.0 to 1.0 | 2 |
| Intermediate type | 70 × 28T | 1.0 to 1.5 | 2 |
| Special type | 150 × 100 × 28T | 1.5 to 2.0 | 1 |
| | | 2.0 to 2.5 | 2 |
| | | 2.5 to 3.0 | 3 |
| | | 3.0 to 4.0 | 4 |

| | | |
|---|---|---|
| Measurement | 4.0 or more | Measuring point |

The magnetic markers 1 are installed at intervals of about 20 m on a straight pipe and installed at each inflection point on a curved pipe. Moreover, the magnetic marker 1 is attached to a point where the diameter or material of the pipe is changed. Furthermore, the magnetic marker 1 is installed at a point where a connection pipe is branched from a main pipe and at a terminal of the pipe. The magnetic markers 1 are installed at intervals of 1 m in each direction at a point branched from the main pipe (including manhole branch). Moreover, at least one magnetic marker 1 is installed between manholes. The magnetic marker 1 is also attached to a point of each of various control units or valves. However, the magnetic marker 1 may be installed at a measuring point when the construction is impossible. Besides, the magnetic marker 1 may be installed in an area which is recognized as necessary according to an ordering entity's demand.

The magnetic marker 1 is firmly attached to the upper end of the underground facility (e.g., pipe) before laying the corresponding facility. The magnetic marker 1 is installed in the following manner. First, after all foreign materials are removed from the position of the pipe, to which the magnetic marker 1 is to be attached, using sandpaper, the magnetic marker 1 is attached to the corresponding position. After the magnetic marker 1 is attached to the pipe, care should be taken so that the attached magnetic marker 1 may not be separated from the pipe while the pipe is covered with earth. When a set of two or three magnetic markers 1 is installed, the magnetic markers 1 should be spaced at intervals of 7 to 10 cm.

When the magnetic marker 1 is attached to the pipe, an adhesive such as epoxy having strong adhesion (which may vary according to the use) may be used. However, the magnetic marker 1 should not be separated from the pipe until the bonded magnetic marker 1 is cured.

It is necessary to obtain accurate absolute coordinates (N, E and Z) of the center of the magnetic marker 1 attached to the pipe using a total station (TS) or global positioning system (GPS) measurement system before laying the pipe to which the magnetic marker 1 is attached.

Magnetic fields are measured using three magnetic field sensors 12a, 12b and 12c located in a support rod 11 provided in the detection apparatus 100. Here, while the detection apparatus 100 equipped with the three magnetic field sensors is illustrated, the detection apparatus 100 may include more than three magnetic field sensors depending on the environment of the underground facility. The magnetic field sensors may be implemented as fluxgate sensors 12a, 12b and 12c, and the specifications of the fluxgate sensors are as shown in the following Table 2.

TABLE 2

| 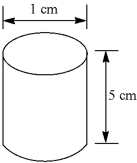 | |
|---|---|
| Item | Dimensions |
| Measurement range | ±100 μT (±1 G) |
| Resolution | 100 nT (1 mG) |
| Size of magnetic sensor | Diameter: 1 cm, Length: 5 cm |
| Weight of magnetic sensor | 10 g |

As shown in (b) of FIG. 1, the fluxgate sensors 12a, 12b and 12c are spaced from each other in the support rod 11 from a front end 11a facing the ground. The fluxgate sensors 12a, 12b and 12c are arranged in a straight line on the axis of the support rod 11. When the front end 11a of the support rod 11 is brought into contact with the ground and erected vertically, the support rod 11 is installed such that the first sensor 12a is located on the ground, the second sensor 12b is located about 25 cm from the ground, and the third sensor 12c is located about 50 cm from the ground.

The detection apparatus 100 is provided with a horizontal sensor 30 for measuring the vertical state of the support rod 11. The detection apparatus 100 typically detects the vertically erected support rod 11 to detect a ferromagnetic substance, and determines the vertical state of the support 11 using the horizontal sensor 30.

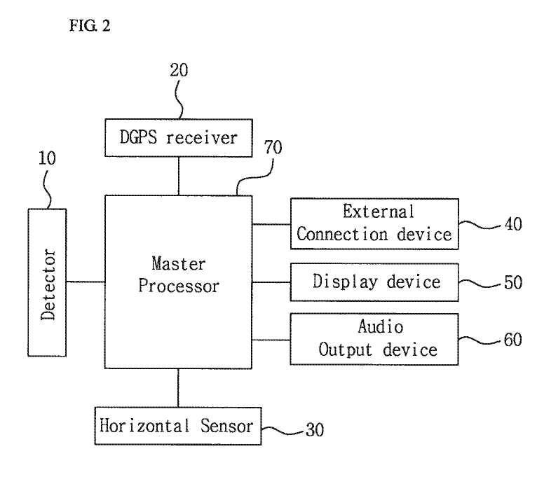

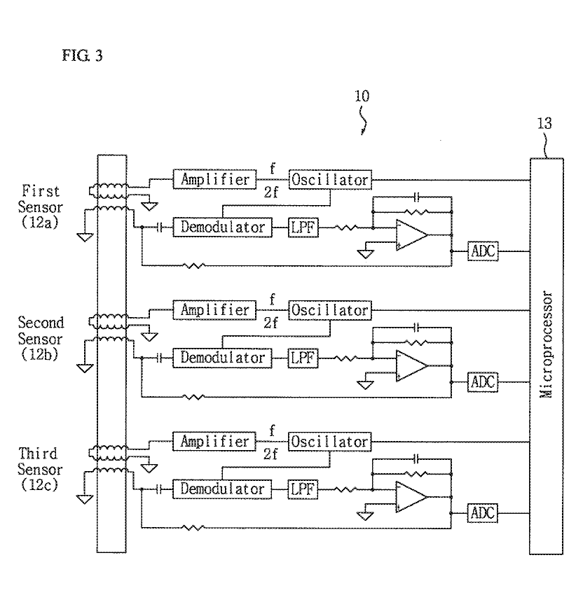

FIG. 2 is a block diagram showing an apparatus for detecting an underground facility in accordance with a preferred embodiment of the present invention, and FIG. 3 is a circuit diagram showing the configuration of a detector in FIG. 2.

Referring to FIG. 2, the detection apparatus 100 comprises a detector 10, a differential global positioning system (DGPS) receiver 20, a horizontal sensor 30, an external connection device 40, a display device 50, an audio output device 60, and a master processor 70.

As shown in FIG. 3, the detector 10 comprises a plurality of sensors 12a, 12b and 12c, a plurality of oscillators for generating a frequency to each sensor, a plurality of amplifiers for amplifying the frequency generated by each oscillator, a plurality of demodulators for processing magnetic field data measured by the sensors 12a, 12b and 12c and providing output signals, a plurality of low pass filters (LPFs), a plurality of comparators, a plurality of analog-digital converters (ADCs) for converting analog data into digital data, and a microprocessor 13 for measuring magnetic fields by controlling the plurality of sensors 12a, 12b and 12c and collecting the measured magnetic field data. The amplifier, the oscillator, the demodulator, the LPF, the comparator, and the ADC are provided in each sensor.

In this embodiment, while the detector 10 comprising three magnetic field sensors 12a, 12b and 12c is disclosed, the detector 10 may comprise at least four magnetic field sensors. Each of the sensors 12a, 12b and 12c measures the magnetic field (i.e., magnetic intensity) generated from the magnetic marker 1 in each position. The magnetic field sensors 12a, 12b and 12c may be implemented as fluxgate sensors. The fluxgate sensors 12a, 12b and 12c are vector sensors and measure average magnetic field data corresponding to each sensing axis.

The microprocessor 13 transmits the digital magnetic field data converted by the ADCs to the master processor 70 through an input interface (not shown).

The DGPS receiver 20 measures the horizontal position of the detection apparatus 100. A differential global positioning system (DGPS) is a GPS measurement system using a relative positioning method, in which the factors causing errors (such as satellite orbit errors, satellite clock errors, ionospheric errors, tropospheric errors, multipath errors, receiver errors, etc.) are corrected using already known coordinates of a reference point (i.e., reference station), and these errors are reduced as much as possible to obtain a more accurate position. Here, the error is calculated based on the pseudo-range. The reference station compares the received pseudo-range with the actually calculated pseudo-range error of a satellite and transmits an offset value, an error (correction data) calculated by the pseudo-range, to a receiver that wants to know its location. At present, there are two types of correction data services. One is a satellite-based augmentation system (SBAS) using a geostationary satellite and the other is the DGPS using a terrestrial correction reference station. The SBAS using the geostationary satellite provides correction information using a satellite orbiting 36,000 km from the earth and comprises two systems such as a wide area terrestrial reference station and a communication satellite. A terrestrial monitoring reference station receives GPS satellite positioning signals and transmits the data to a supervisory control base station, and a wide area control base station generates correction data and transmits the data to the geostationary satellite through the terrestrial reference station to provide the correction data to a user. There are various SBASs under different names such as USA WAAS, European EGNOS, Japanese MSAS, etc. on earth, which are mainly used in facilities for flight communications. DGPS correction signals are broadcast to a specific receiver using the satellite such that the user can properly use the data wherever the user is located.

According to the SBAS technology, a GPS receiving station is installed at a reference point whose position is known to receive satellite signals, correct the error, and provide the corrected value to a mobile station through a terrestrial wireless communication network. When the number of the reference stations in a given area is increased, the error can be reduced to a few centimeters. The SBASs are classified into a real-time process, which corrects the value received in the reference station and transmits the correction value to a mobile station in real time, and a post-process, which corrects the position by first performing the measurement and then processing the stored measurement data.

According to the DGPS technology using the terrestrial correction reference station, a public institution such as the Ministry of Maritime Affairs and Fisheries transmits DGPS correction data in the form of a radio beacon to various vessels such as boats, ships, etc. Here, as the correction data, a single format is used in the same manner as the SBAS, and the beacon signal can be received by simple amplitude modulation at the receiver.

The horizontal sensor 30 may be implemented as an electronic level meter and measures the vertical state of the support rod 11.

The external connection device 40 is an interface means which connects the detection apparatus 100 to a computer, PDA, ultra mobile PC, etc. which is suitable to be connected to the detection apparatus 100. For example, the external connection device 40 connects the detection apparatus 100 to a GIS system in a wireless or wired manner and accesses the underground information present in the area under the measurement from the GIS system under the control of the detection apparatus 100.

The external connection device 40 may be implemented as a wired/wireless communication means, a universal serial bus (USB) module, a Bluetooth module, etc.

The display device 50 displays the status and results according to the operation of the detection apparatus 100. The display device 50 may be implemented as a display means such as a liquid crystal display (LCD) device and may be implemented as a touch screen combined with a touch pad. When the display device 50 is implemented as the touch screen, the display device 50 may be used as an input means as well as an output means.

The audio output device 60 generates an audio signal and output the signal to the outside through a loudspeaker (not shown) under the control of the master processor 70.

The master processor 70 processes the magnetic field data, received from the microprocessor 13 of the detector 10, and displays the data in the form of numerical values or a graphic on the display device 50 and/or generates an audio signal and outputs the signal to the audio output device 60.

Moreover, the master processor 70 measures the depth of the magnetic marker 1 by performing a factor analysis on the magnetic field data measured by the detector 10.

The master processor 70 receives the current position of the detection apparatus 100 through the DGPS receiver 20 and stores the received data in a memory (not shown). The master processor 70 compares the coordinates received through the DGPS receiver 20 with the location information of the magnetic marker 1 constructed during installation of the magnetic marker 1 and, when the detection apparatus 100 is present within a radius of 5 m, outputs a sound signal informing that the detection apparatus 100 is adjacent to the magnetic marker 1 through the audio output device 60. Here, the detection apparatus 100 can approach the magnetic marker 1 within a radius of 1 m, which is the DGPS margin of error. The location information of the magnetic marker 1 is constructed as a database by measuring the location of the magnetic marker 1 during installation of the magnetic marker 1 and by processing the location information of the magnetic marker 1.

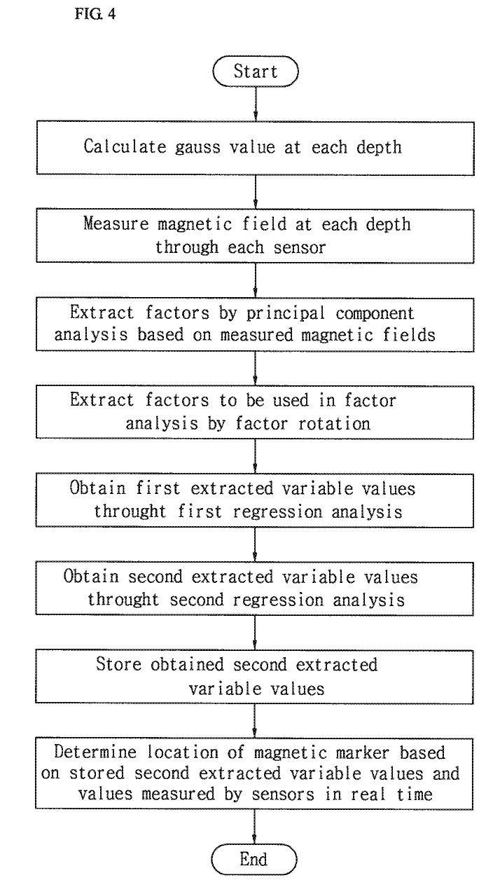

FIG. 4 is a flowchart showing a method for detecting a location of an underground facility in accordance with a preferred embodiment of the present invention.

First, a theoretical value (i.e., gauss value) of the magnetic flux density at each depth is calculated before detecting a magnetic marker 1 attached to an underground facility using the detection apparatus 100. The magnetic flux density formed by the magnetic marker 1 on the z-axis is given by the following Formula 1:

$${B}_{z} - \frac{{μ}_{0} {M}_{0}}{2} [ \frac{z}{\sqrt{{z}^{2} + {b}^{2}}} - \frac{z - L}{\sqrt{{( z - L )}^{2} + {b}^{2}}} ] \qquad [ Formula 1 ]$$

wherein

1 Tesla=10000 Gauss

μ₀=4π×10⁻⁷

B₀=Magnetic flux density (T)

M₀=Application variable.

To calculate the application variable M₀, the following Formula 2 can be derived from the above Formula 1.

$${M}_{0} = \frac{{B}_{z} \times 2}{{μ}_{0} [ \frac{z}{\sqrt{{z}^{2} + {b}^{2}}} - \frac{z - L}{\sqrt{{( z - L )}^{2} + {b}^{2}}} ]} \qquad [ Formula 2 ]$$

For example, when the surface magnetic flux density B₀ of an intermediate type magnetic marker is 900 G (=0.09 T), the application variable M₀ is calculated by substituting the dimensions (70(D)×28(L)T) of the intermediate type magnetic marker into the above Formula 2 as shown in the following Formula 3.

$$\begin{matrix}{M}_{0} = \frac{0.09 \times 2}{( 4 π \times {10}^{- 7} ) [ \frac{0}{\sqrt{{0}^{2} + {3.5}^{2}}} - \frac{0 - 2.8}{\sqrt{{( 0 - 2.8 )}^{2} + {3.5}^{2}}} ]} \\ = 229294.9966\end{matrix} \qquad [ Formula 3 ]$$

Therefore, in the case of the intermediate type magnetic marker, the respective values are as shown in the following Table 3.

TABLE 3

| | | | Space | |
|---|---|---|---|---|
| | | Height | permeability | Application variable |
| Classification | Radius | (L) | (μ₀) | (M₀) |
| Intermediate | 3.5 cm | 2.8 cm | 4π × 10⁻⁷ H/m | 229294.9966 |
| type | | | | |

When the values shown in Table 3 are substituted in Formula 1, the gauss values (i.e., the magnetic flux densities) of the intermediate type magnetic marker at the respective depths (i.e., distances) can be obtained as shown in Table 4.

TABLE 4

| Distance | Gauss |
|---|---|
| (cm) | (G) |
| 0 | 900 |
| 1 | 1054.694173 |
| 2 | 1035.813183 |
| 3 | 855.405252 |
| 4 | 616.984455 |
| 5 | 413.568731 |
| 6 | 272.306835 |
| 7 | 181.825229 |
| 8 | 124.72106 |
| 9 | 88.142729 |
| 10 | 64.097598 |
| 11 | 47.833645 |
| 12 | 36.523869 |
| 13 | 28.455506 |
| 14 | 22.565042 |
| 15 | 18.174673 |
| 16 | 14.841299 |
| 17 | 12.268239 |
| 18 | 10.252407 |
| 19 | 8.651928 |
| 20 | 7.365837 |
| 21 | 6.321051 |
| 22 | 5.46384 |
| 23 | 4.754139 |
| 24 | 4.16168 |
| 25 | 3.663319 |
| 26 | 3.241164 |
| 27 | 2.881239 |
| 28 | 2.572524 |
| 29 | 2.306255 |
| 30 | 2.075399 |
| 31 | 1.874276 |
| 32 | 1.698261 |
| 33 | 1.543564 |
| 34 | 1.407059 |
| 35 | 1.286155 |
| 36 | 1.178689 |
| 37 | 1.082848 |
| 38 | 0.997105 |
| 39 | 0.920167 |
| 40 | 0.850932 |
| 41 | 0.788463 |
| 42 | 0.731953 |
| 43 | 0.680710 |
| 44 | 0.634135 |
| 45 | 0.591708 |
| 46 | 0.552979 |
| 47 | 0.517554 |
| 48 | 0.485088 |
| 49 | 0.455279 |
| 50 | 0.427861 |
| 51 | 0.402599 |
| 52 | 0.379285 |
| 53 | 0.357736 |
| 54 | 0.337787 |
| 55 | 0.319293 |
| 56 | 0.302124 |
| 57 | 0.286163 |
| 58 | 0.271306 |
| 59 | 0.257460 |
| 60 | 0.244539 |
| 61 | 0.232468 |
| 62 | 0.221178 |
| 63 | 0.210607 |
| 64 | 0.200698 |
| 65 | 0.191402 |
| 66 | 0.182670 |
| 67 | 0.174461 |
| 68 | 0.166737 |
| 69 | 0.159461 |
| 70 | 0.152603 |
| 71 | 0.146132 |
| 72 | 0.140022 |
| 73 | 0.134247 |
| 74 | 0.128786 |
| 75 | 0.123616 |
| 76 | 0.118720 |
| 77 | 0.114079 |
| 78 | 0.109676 |
| 79 | 0.105497 |
| 80 | 0.101528 |
| 81 | 0.097755 |
| 82 | 0.094167 |
| 83 | 0.090752 |
| 84 | 0.087500 |
| 85 | 0.084402 |
| 86 | 0.081448 |
| 87 | 0.078630 |
| 88 | 0.075941 |
| 89 | 0.073373 |
| 90 | 0.070920 |
| 91 | 0.068574 |
| 92 | 0.066331 |
| 93 | 0.064185 |
| 94 | 0.062130 |
| 95 | 0.060162 |
| 96 | 0.058277 |
| 97 | 0.056469 |
| 98 | 0.054735 |
| 99 | 0.053071 |
| 100 | 0.051474 |
| . . . | . . . |

When the effective measurement range of the sensor is 1.2 to −1.2 G, the range excluding the range of 0 to 0.3 G, which is difficult to detect due to low magnetic flux density caused by the long distance, is the effective measurement range of the intermediate type magnetic marker, and the effective measurement range is as shown in the following Table 5.

TABLE 5

| Distance | Gauss |
|---|---|
| (cm) | (G) |
| 36 | 1.178689 |
| 37 | 1.082848 |
| 38 | 0.997105 |
| 39 | 0.920167 |
| 40 | 0.850932 |
| 41 | 0.788463 |
| 42 | 0.731953 |
| 43 | 0.680710 |
| 44 | 0.634135 |
| 45 | 0.591708 |
| 46 | 0.552979 |
| 47 | 0.517554 |
| 48 | 0.485088 |
| 49 | 0.455279 |
| 50 | 0.427861 |
| 51 | 0.402599 |
| 52 | 0.379285 |
| 53 | 0.357736 |
| 54 | 0.337787 |
| 55 | 0.319293 |
| 56 | 0.302124 |
| 57 | 0.286163 |
| 58 | 0.271306 |
| 59 | 0.257460 |
| 60 | 0.244539 |
| 61 | 0.232468 |
| 62 | 0.221178 |
| 63 | 0.210607 |
| 64 | 0.200698 |
| 65 | 0.191402 |
| 66 | 0.182670 |
| 67 | 0.174461 |
| 68 | 0.166737 |
| 69 | 0.159461 |
| 70 | 0.152603 |
| 71 | 0.146132 |
| 72 | 0.140022 |
| 73 | 0.134247 |
| 74 | 0.128786 |
| 75 | 0.123616 |
| 76 | 0.118720 |
| 77 | 0.114079 |
| 78 | 0.109676 |
| 79 | 0.105497 |
| 80 | 0.101528 |
| 81 | 0.097755 |
| 82 | 0.094167 |
| 83 | 0.090752 |
| 84 | 0.087500 |
| 85 | 0.084402 |
| 86 | 0.081448 |
| 87 | 0.078630 |
| 88 | 0.075941 |
| 89 | 0.073373 |
| 90 | 0.070920 |
| 91 | 0.068574 |
| 92 | 0.066331 |
| 93 | 0.064185 |
| 94 | 0.062130 |
| 95 | 0.060162 |
| 96 | 0.058277 |
| 97 | 0.056469 |
| 98 | 0.054735 |
| 99 | 0.053071 |
| 100 | 0.051474 |
| 101 | 0.049941 |
| 102 | 0.048468 |
| 103 | 0.047052 |
| 104 | 0.045691 |
| 105 | 0.044382 |
| 106 | 0.043122 |
| 107 | 0.041910 |
| 108 | 0.040742 |
| 109 | 0.039618 |
| 110 | 0.038534 |
| 111 | 0.037490 |
| 112 | 0.036483 |
| 113 | 0.035512 |
| 114 | 0.034575 |
| 115 | 0.033670 |
| 116 | 0.032797 |
| 117 | 0.031954 |
| 118 | 0.031139 |
| 119 | 0.030352 |

The respective magnetic flux densities (i.e., the magnetic fields) at the different depths of the intermediate type magnetic marker 1 are measured using the three sensors based on the calculated gauss values. The measured values are as shown in the following Table 6.

TABLE 6

| 36 cm | | 37 cm | | 38 cm | | 39 cm | | 40 cm | | 41 cm | | 42 cm | |
|---|---|---|---|---|---|---|---|---|---|---|---|---|---|
| 36 | 1.178689 | 37 | 1.082848 | 38 | 0.997105 | 39 | 0.920167 | 40 | 0.850932 | 41 | 0.788463 | 42 | 0.731953 |
| 61 | 0.232468 | 62 | 0.221178 | 63 | 0.210607 | 64 | 0.200698 | 65 | 0.191402 | 66 | 0.182670 | 67 | 0.174461 |
| 86 | 0.081448 | 87 | 0.078630 | 88 | 0.075941 | 89 | 0.073373 | 90 | 0.070920 | 91 | 0.068574 | 92 | 0.066331 |
| 43 cm | | 44 cm | | 45 cm | | 46 cm | | 47 cm | | 48 cm | | 49 cm | |
| 43 | 0.680710 | 44 | 0.634135 | 45 | 0.591708 | 46 | 0.552979 | 47 | 0.517554 | 48 | 0.485088 | 49 | 0.455279 |
| 68 | 0.166737 | 69 | 0.159461 | 70 | 0.152603 | 71 | 0.146132 | 72 | 0.140022 | 73 | 0.134247 | 74 | 0.128786 |
| 93 | 0.064185 | 94 | 0.062130 | 95 | 0.060162 | 96 | 0.058277 | 97 | 0.056469 | 98 | 0.054735 | 99 | 0.053071 |
| 50 cm | | 51 cm | | 52 cm | | 53 cm | | 54 cm | | 55 cm | | 56 cm | |
| 50 | 0.427861 | 51 | 0.402599 | 52 | 0.379285 | 53 | 0.357736 | 54 | 0.337787 | 55 | 0.319293 | 56 | 0.302124 |
| 75 | 0.123616 | 76 | 0.118720 | 77 | 0.114079 | 78 | 0.109676 | 79 | 0.105497 | 80 | 0.101528 | 81 | 0.097755 |
| 100 | 0.051474 | 101 | 0.049941 | 102 | 0.048468 | 103 | 0.047052 | 104 | 0.045691 | 105 | 0.044382 | 106 | 0.043122 |
| 57 cm | | 58 cm | | 59 cm | | 60 cm | | 61 cm | | 62 cm | | 63 cm | |
| 57 | 0.286163 | 58 | 0.271306 | 59 | 0.257460 | 60 | 0.244539 | 61 | 0.232468 | 62 | 0.221178 | 63 | 0.210607 |
| 82 | 0.094167 | 83 | 0.090752 | 84 | 0.087500 | 85 | 0.084402 | 86 | 0.081448 | 87 | 0.078630 | 88 | 0.075941 |
| 107 | 0.041910 | 108 | 0.040742 | 109 | 0.039618 | 0 | 0.038534 | 111 | 0.037490 | 112 | 0.036483 | 113 | 0.035512 |

| 64 cm | | 65 cm | | 66 cm | | 67 cm | | 68 cm | | 69 cm | |
|---|---|---|---|---|---|---|---|---|---|---|---|
| 64 | 0.200698 | 65 | 0.191402 | 66 | 0.182670 | 67 | 0.174461 | 68 | 0.166737 | 69 | 0.159461 |
| 89 | 0.073373 | 90 | 0.070920 | 91 | 0.068574 | 92 | 0.066331 | 93 | 0.064185 | 94 | 0.062130 |
| 114 | 0.034575 | 115 | 0.033670 | 116 | 0.032797 | 117 | 0.031954 | 118 | 0.031139 | 119 | 0.030352 |

A factor analysis is performed based on the values measured by the three sensors 12a, 12b and 12e at the respective depths. In other words, the master processor 70 measures the magnetic fields at the respective depths through the three sensors included in the detector 10 based on the gauss values calculated from the respective depths. Then, the master processor 70 performs the factor analysis based on the magnetic field values measured from the respective depths. Here, the factor analysis is performed using a Statistical Package for the Social Sciences (SPSS), which is a statistical analysis software developed for data management and statistical analysis by the University of Chicago in 1969.

During the factor analysis, the master processor 70 extracts the factors from the measurement values output from the three sensors 12a, 12b and 12c using a principal component analysis (PCA). The principal component analysis is mainly used in the first step of the analysis to examine the characteristics and number of the factors. The component, which maximizes the distribution, is extracted using all the factors, and the factors are extracted from a factor with a large distribution in a descending order according to the number of variables.

The master processor 70 performs a factor rotation using varimax on the extracted factors. In other words, the master processor 70 extracts first factors, which will be used in the factor analysis, from the extracted factors.

For example, referring to the total distribution table of Table 7, it can be seen that only a single component is extracted at an accumulation of 99.247% from component 1, and referring to the community table of Table 8, the extracted factors from the three sensors are 98.6%, 99.9%, and 99.2%, respectively.

TABLE 7

| | Initial eigenvalue | | | Extracted sum of squares | | |
|---|---|---|---|---|---|---|
| | | Distri- | Accu- | | Distri- | Accu- |
| | | bution | mulation | | bution | mulation |
| Component | Sum | % | % | Sum | % | % |
| 1 | 2.977 | 99.247 | 99.247 | 2.977 | 99.247 | 99.247 |
| 2 | 0.023 | 0.752 | 99.999 | | | |
| 3 | 0.000 | 0.001 | 100.000 | | | |

TABLE 8

| | Initial stage | Extraction |
|---|---|---|
| Sensor-1 | 1.000 | 0.986 |
| Sensor-2 | 1.000 | 0.999 |
| Sensor-3 | 1.000 | 0.992 |

The master processor 70 extracts second factors by performing a regression analysis on the first factors. The regression analysis excludes highly correlated independent factors in consideration of multicollinearity. Examining the correlation coefficients between the extracted variables and the sensors 12a, 12b and 12c as shown in Table 9, sensor-2 exhibiting a very high correlation with the dependent variable through the regression analysis is excluded from the regression analysis.

TABLE 9

| | Extracted | | | |
|---|---|---|---|---|
| | variables | Sensor-1 | Sensor-2 | Sensor-3 |
| Extracted variables | 1.000 | 0.995 | 1.000 | 0.997 |
| Sensor-1 | 0.995 | 1.000 | 0.993 | 0.984 |
| Sensor-2 | 1.000 | 0.993 | 1.000 | 0.998 |
| Sensor-3 | 0.997 | 0.984 | 0.998 | 1.000 |

The master processor 70 derives a regression formula as shown in the following Formula 4 through the regression analysis. Here, coefficient a is −2.585, coefficient b is 1.546, and coefficient c is 36.918. The obtained coefficients are substituted into the following Formula 4 to obtain first extracted variables (Y₁) with respect to the first and third sensors at the respective depths.

Y₁=a+bX₁+cX₃ [Formula 4]

The extracted variable values with respect to the first and third sensors 12a and 12c obtained based on the regression formula (Formula 4) by the first regression analysis are as shown in the following Table 10.

TABLE 10

| | | | First extracted variables |
|---|---|---|---|
| Depth | Sensor-1 | Sensor-3 | (Y₁) |
| 36 | 1.178689 | 0.081448 | 2.23954 |
| 37 | 1.082848 | 0.078630 | 1.99034 |
| 38 | 0.997105 | 0.075941 | 1.76054 |
| 39 | 0.920167 | 0.073373 | 1.54806 |
| 40 | 0.850932 | 0.070920 | 1.35117 |
| 41 | 0.788463 | 0.068574 | 1.16829 |
| 42 | 0.731953 | 0.066331 | 0.9981 |
| 43 | 0.680710 | 0.064185 | 0.83943 |
| 44 | 0.634135 | 0.062130 | 0.69118 |
| 45 | 0.591708 | 0.060162 | 0.55248 |
| 46 | 0.552979 | 0.058277 | 0.4225 |
| 47 | 0.517554 | 0.056469 | 0.30047 |
| 48 | 0.485088 | 0.054735 | 0.18576 |
| 49 | 0.455279 | 0.053071 | 0.07779 |
| 50 | 0.427861 | 0.051474 | −0.02398 |
| 51 | 0.402599 | 0.049941 | −0.11999 |
| 52 | 0.379285 | 0.048468 | −0.2107 |
| 53 | 0.357736 | 0.047052 | −0.29652 |
| 54 | 0.337787 | 0.045691 | −0.37775 |
| 55 | 0.319293 | 0.044382 | −0.45475 |
| 56 | 0.302124 | 0.043122 | −0.5278 |
| 57 | 0.286163 | 0.041910 | −0.59716 |
| 58 | 0.271306 | 0.040742 | −0.66309 |
| 59 | 0.257460 | 0.039618 | −0.7258 |
| 60 | 0.244539 | 0.038534 | −0.78551 |
| 61 | 0.232468 | 0.037490 | −0.84238 |
| 62 | 0.221178 | 0.036483 | −0.89662 |
| 63 | 0.210607 | 0.035512 | −0.94837 |
| 64 | 0.200698 | 0.034575 | −0.99778 |
| 65 | 0.191402 | 0.033670 | −1.04501 |
| 66 | 0.182670 | 0.032797 | −1.09015 |
| 67 | 0.174461 | 0.031954 | −1.13333 |
| 68 | 0.166737 | 0.031139 | −1.17469 |
| 69 | 0.159461 | 0.030352 | −1.21429 |

Then, second extracted variable values are calculated by performing a second regression analysis on the extracted variable values (Y₁) obtained from the first and third sensors using the gauss values obtained from the second sensor. The regression formula derived through the second regression analysis is as shown in the following Formula 5:

Y₂=a+bX₂+cY₁ [Formula 5]

wherein coefficients a, b and c are −1.242, 10.029 and 0.500, respectively.

The second extracted variable values calculated by substituting the gauss values of the second sensor and the first extracted variable values into Formula 5 are as shown in the following Table 11.

TABLE 11

| | | First extracted variables | Second extracted |
|---|---|---|---|
| Depth | Sensor-2 | (Y₁) | variables (Y₂) |
| 36 | 0.232468 | 2.23954 | 2.20926 |
| 37 | 0.221178 | 1.99034 | 1.97142 |
| 38 | 0.210607 | 1.76054 | 1.75049 |
| 39 | 0.200698 | 1.54806 | 1.54487 |
| 40 | 0.191402 | 1.35117 | 1.35319 |
| 41 | 0.182670 | 1.16829 | 1.17416 |
| 42 | 0.174461 | 0.9981 | 1.00674 |
| 43 | 0.166737 | 0.83943 | 0.84993 |
| 44 | 0.159461 | 0.69118 | 0.70283 |
| 45 | 0.152603 | 0.55248 | 0.56469 |
| 46 | 0.146132 | 0.4225 | 0.43479 |
| 47 | 0.140022 | 0.30047 | 0.3125 |
| 48 | 0.134247 | 0.18576 | 0.19722 |
| 49 | 0.128786 | 0.07779 | 0.08846 |
| 50 | 0.123616 | −0.02398 | −0.01428 |
| 51 | 0.118720 | −0.11999 | −0.11139 |
| 52 | 0.114079 | −0.2107 | −0.20329 |
| 53 | 0.109676 | −0.29652 | −0.29036 |
| 54 | 0.105497 | −0.37775 | −0.3729 |
| 55 | 0.101528 | −0.45475 | −0.4512 |
| 56 | 0.097755 | −0.5278 | −0.52557 |
| 57 | 0.094167 | −0.59716 | −0.59624 |
| 58 | 0.090752 | −0.66309 | −0.66346 |
| 59 | 0.087500 | −0.7258 | −0.72742 |
| 60 | 0.084402 | −0.78551 | −0.78835 |
| 61 | 0.081448 | −0.84238 | −0.84642 |
| 62 | 0.078630 | −0.89662 | −0.9018 |
| 63 | 0.075941 | −0.94837 | −0.95465 |
| 64 | 0.073373 | −0.99778 | −1.00511 |
| 65 | 0.070920 | −1.04501 | −1.05332 |
| 66 | 0.068574 | −1.09015 | −1.09943 |
| 67 | 0.066331 | −1.13333 | −1.14352 |
| 68 | 0.064185 | −1.17469 | −1.18572 |
| 69 | 0.062130 | −1.21429 | −1.22613 |

The regression formula derived through the first and second regression analyses is as shown in the following Formula 6.

Y₂=d+cX₂+f(a+bX₁+cX₃) [Formula 6]

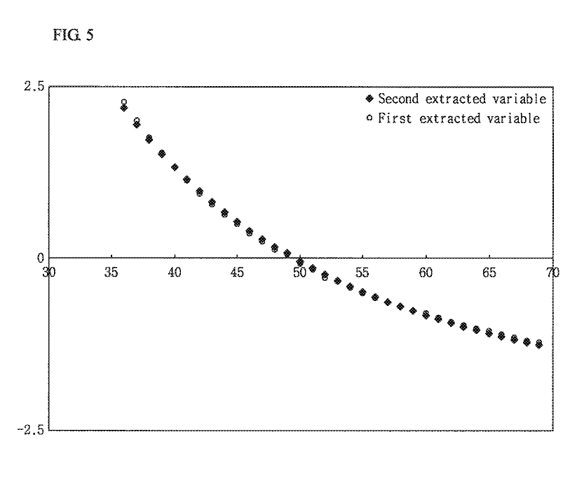

When the above Formula 6 is satisfied, the master processor 70 can determine that the magnetic marker 1 is present. The above Formula 6 can be represented by a graph shown in FIG. 5. The respective variable values are plotted on the graph, and thus it is possible to determine the presence and depth (i.e., the distance from the surface of the earth to the magnetic marker) of the magnetic marker 1 from the point where all variables are satisfied.

The master processor 70 quantifies the gauss value of each sensor as a variable (i.e., second extracted variable value) through the factor analysis and the regression analysis and constructs a database. Therefore, if the regression formula is satisfied (established) when the measurement values (i.e., the magnetic field data) obtained in real time by the respective sensors 12a, 12b and 12c are substituted into the regression formula (Formula 6), the master processor 70 determines that the magnetic marker 1 is present. Then, the master processor 70 accesses the depth corresponding to the second extracted variable value from the quantified data when the regression formula is satisfied and outputs it as the depth of the magnetic marker 1.

As described above, according to the present invention, it is possible to accurately determine the presence and depth of the magnetic marker by quantifying the gauss value of each sensor as a variable through the factor analysis and the regression analysis and using the quantified data.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for detecting a location of an underground facility, the method comprising the steps of:
calculating a gauss value at each depth of a magnetic marker;
measuring a magnetic field using each sensor at each depth based on the calculated gauss value;
extracting factors by performing a factor analysis on the measured magnetic fields;
obtaining and storing extracted variable values by performing a regression analysis on the extracted factors; and
determining a location of the magnetic marker based on the stored extracted variable values and the values measured by the sensors in real time.

2. The method of claim 1, wherein the gauss value at each depth is calculated by the following formula:
$${B}_{z} = \frac{{μ}_{0} {M}_{0}}{2} [ \frac{z}{\sqrt{{z}^{2} + {b}^{2}}} - \frac{z - L}{\sqrt{{( z - L )}^{2} + {b}^{2}}} ] .$$

3. The method of claim 1, wherein the step of extracting factors comprises the steps of:
extracting first factors by performing a principal component analysis based on the magnetic fields measured by the sensors; and
extracting second factors, which will used in the factor analysis, from the extracted factors by a factor rotation.

4. The method of claim 1, wherein in the step of determining the location of the magnetic marker, if the values measured by the sensors in real time satisfy the following regression formula, it is determined that the magnetic marker is present:
Y₂=a+bX₂+c(a+bX₁+cX₃). [Regression formula]

5. The method of claim 4, wherein in the step of determining the location of the magnetic marker, the depth corresponding to the extracted variable value when the above regression formula is satisfied is determined as the location of the magnetic marker.

6. An apparatus for detecting a location of an underground facility, the apparatus comprising:
a detector including at least three magnetic field sensors for detecting magnetic fields generated from a magnetic marker; and
a master processor for quantifying a gauss value of each sensor at each depth of the magnetic marker as one data by performing a factor analysis and a regression analysis and determining a location of the magnetic marker with respect to the measurement values output from the detector based on the quantified data.

7. The apparatus of claim 6, wherein the master processor determines that the magnetic marker is present if the measurement values satisfy the following regression formula:
Y₂=d+cX₂+f(a+bX₁+cX₃). [Regression formula]

8. The apparatus of claim 7, wherein the master processor determines that the depth corresponding to the quantified data when the above regression formula is satisfied is the location of the magnetic marker.
